(19) United States
(12) Patent Application Publication
(10) Pub. No.: US 2014/0335886 A1
(43) Pub. Date: Nov. 13, 2014

(54) NETWORK IDENTIFIER POSITION DETERMINING SYSTEM AND METHOD FOR SAME

(71) Applicants: Dong jin Kim, Seocho-gu (KR); Wang geun Lee, Youngdeungpo-gu (KR); Hang gi Lee, Guro-gu (KR); Sun Ju Hur, Jung-gu (KR); In gwi Kim, Yangcheon-gu (KR); Jeong Hwan Seo, Paju-si (KR); Choong sup Shim, Yongsan-gu (KR)

(72) Inventors: Dong jin Kim, Seocho-gu (KR); Wang geun Lee, Youngdeungpo-gu (KR); Hang gi Lee, Guro-gu (KR); Sun Ju Hur, Jung-gu (KR); In gwi Kim, Yangcheon-gu (KR); Jeong Hwan Seo, Paju-si (KR); Choong sup Shim, Yongsan-gu (KR)

(73) Assignee: THINKPOOL CO., LTD, Seoul (KR)

(21) Appl. No.: 14/238,953

(22) PCT Filed: Jul. 31, 2012
(86) PCT No.: PCT/KR2012/006090

§ 371 Date: Apr. 7, 2014

(30) Foreign Application Priority Data
Aug. 17, 2011 (KR) 10-2011-0081595

(51) Int. Cl. H04L 29/08; H04W 4/02

(52) U.S. Cl. CPC H04L 67/18; H04W 4/02
USPC 455/456.1; 709/224

(57) ABSTRACT

A network identifier position determination system and method. The network identifier position determination system includes a network identification module. When a terminal is connected to a network system through a wired/wireless network, the network identification module checks a network identifier that the terminal uses in order to be connected to the network system. A positioning module checks position information of a user corresponding to the terminal that is connected to the network system using the network identifier. A control module which maps a determination position that is determined based on the position information checked by the positioning module to a position of the network identifier.

### TECHNICAL FIELD

The present invention relates to a system and a method that can determine a physical position (a geographical coordinate, a local address, a specific building or factory, or the like instead of an address on wired/wireless communication) corresponding to a network identifier (e.g. an Internet protocol (IP) address), and more particularly, to a system and a method that can check a network identifier of a terminal that is connected to a specific network system through a wired/wireless network and accurately determine the physical position of the network identifier by checking a position of user who is using the terminal.

### BACKGROUND ART

In response to the development of networks, many people use a variety of services or functions from network systems to which they are connected. In order to be connected to a network system, a terminal that can be connected to a network (e.g. a computer, a notebook computer, a smart phone, or a tablet computer) and a network identifier (e.g., an Internet protocol (IP) address) that identifies the terminal to the network should be needed.

Thanks to rapid development of communication technology and rapid spread of mobile terminals, many location-based services are released to the market. In order to provide a location-based service to users, the position of users must be determined. While the position of a mobile phone such as a smart phone is provided quite accurately in cooperation with the global positioning system (GPS), the location-based service (LBS), or the like, the position of a terminal connected to a network system is not so accurate.

A variety of methods of determining the position of a terminal connected to the network is known. Typical methods can be a method of detecting the position of the terminal using a separate device (e.g. a GPS module) equipped with the terminal and a method of detecting the position of the terminal based on an IP address received from an external system (e.g. an Internet service provider (ISP) system).

First, the method of using the separate device, such as the GPS module, equipped with the fixed terminal, such as a computer, is rarely used since terminal users do not feel it necessary. Therefore, most methods of determining the position of a connected terminal which are used at present are based on the IP address provided from the ISP system. Of course, the fact in that the GPS module is equipped with the mobile terminal such as the smart phone is a separate issue.

However, the external system (e.g. the ISP system) can only roughly detect the position of the terminal based on the IP address because of substantial reasons. As for the IP, even Internet protocol version 4 (IPv4) theoretically allows 4.3 billion IP addresses. (IPv4 has address blocks in the shape of 000.000.000.000. Each “000” indicates the eighth power of 2 or 256. Since there is the fourth power of 256, the entire number of cases becomes 4.3 billions.) It is not easy to set position values by converting the physical positions of such an enormous number of IP addresses into coordinates. Therefore, Internet service providers provide IP addresses according to administrative district units, such as streets or districts, by dividing the IP addresses into cells. However, this also has errors, and thus the accuracy does not exceed 70%.

There are a variety of reasons for errors. For instance, when a company constructs and uses a private network such as a virtual private network (VPN), VPN clients (e.g. terminals of employees) can be connected to an external network using a public IP of a VPN server. In this case, the position of the public IP of the VPN server may be mapped to a number of positions of employees (e.g. branch offices located in other areas away from the main office), thereby leading to an error.

When IPs are dynamically assigned as in the case in which dynamic host configuration protocol (DHCP) is used, IPs from among previously-assigned IPs are selectively assigned to terminals that are to be connected to the network. The terminals rarely have static IPs. Even the static IPs may be set to different positions when the Internet service provider is changed or according to the circumstances of the Internet service provider. Therefore, according to the conventional approach, it is very difficult to accurately detect the physical position of a network identifier (e.g. an IP address) that a network terminal uses.

Accordingly, a system and a method that can relatively accurately detect the physical address of a network identifier that a terminal connected to a network uses are urgently required.

### DISCLOSURE

### Technical Problem

Therefore an object of that the present invention is to provide a system and a method that can accurately detect information on physical positions according to network identifiers.

Also provided are a system and a method that can detect different positions corresponding to one network identifier even when the network identifier is used at the different positions.

Also provided are a system and a method that can detect position information according to network identifiers with an error that is smaller than in the conventional approach in which an Internet service provider detects and provides an IP address-based position.

### Technical Solution

According to an aspect of the present invention for realizing the foregoing object, provided is a network identifier position determination system that includes: a network identification module, wherein, when a terminal is connected to a network system through a wired/wireless network, the network identification module checks a network identifier that the terminal uses in order to be connected to the network system; a positioning module which checks position information of a user corresponding to the terminal that is connected to the network system using the network identifier; and a control module which maps a determination position that is determined based on the position information checked by the positioning module to a position of the network identifier.

The positioning module may check position information of a mobile terminal of the user.

The network identifier position determination system may further include a database (DB). The control module may store the position information of the user in the database so as to match the network identifier. In a case in which a plurality of pieces of position data including the position information is stored in the database for the same network identifier, when at least some of the plurality of pieces of position data stored in the database satisfies a predetermined standard, the control module may determine the determination position based on the at least some of the plurality of pieces of position data that satisfies the predetermined standard.

The predetermined standard may be a case in which a position value of each of the at least some of the plurality of pieces of position data is present at a predetermined distance or less and the number of the at least some of the plurality of pieces of position data is equal to or greater than a predetermined number.

The control module may determine one of the at least some of the plurality of pieces of position that satisfies the predetermined standard to be the determination position or determine a new position calculated using the position value of the at least some of the plurality of pieces of position data to be the determination position.

The determination position can be plural for the same network identifier. The network identifier mapped at the same determination position can be plural.

When position information that satisfies the standard for the same network identifier is newly detected and a new determination position is determined, the control module may be able to change a way how to map the new determination position to the network identifier depending on whether position information corresponding to an existing determination position for a predetermined period is checked.

The control module may receive at least one of information about a connection position where the user is connected to the network system and information about whether or not the user has been connected to the network system from a user system corresponding to the user, and determine whether or not to map the determination position to the position of the network identifier based on the received information.

The control module may receive property information of the network identifier used by the terminal through the terminal, and change a way how to determine the determination position or a way how to map the determined determination position to the network identifier based on the received property information.

When a plurality of network identifiers is used for the same user and determination positions respectively corresponding to the plurality of network identifiers are respectively determined, the control module may receive information about whether or not the user has been connected to the network system at each of the determination positions or whether or not the user has been connected to the network system using each of the plurality of network identifiers from a user system corresponding to the user, and determine whether or not to map each of the determination positions to a corresponding network identifier of the plurality of network identifiers based on the received information.

When a plurality of network identifiers are used for the same user and determination positions respectively corresponding to the plurality of network identifiers are respectively determined, the control module may checks, through a user system corresponding to the user or a network provider system, about whether or not the plurality of network identifiers is usable at the determination positions, respectively, or check whether or not a predetermined network identifier standard is satisfied, and based on a result of the checking process, determine whether or not to map each of the determination positions to a corresponding network identifier of the plurality of network identifiers.

According to another aspect of the present invention for realizing the foregoing object, provided is a network identifier position determination system that includes: a network identification module, wherein, when a terminal is connected to a network system through a wired/wireless network, the network identification module checks a network identifier that the terminal uses in order to be connected to the network system; a positioning module which checks position information of a user corresponding to the terminal that is connected to the network system using the network identifier; and a control module. In a case in which a plurality of pieces of different position information checked by the positioning module is present, when at least some of the plurality of pieces of different position information satisfies a predetermined standard, the control module maps a new position to a position of the network identifier, the new position being mapped as one piece of position information of the at least some of the pieces of position information or a being calculated using position value of the at least some of the pieces of position information.

According to a further aspect of the present invention for realizing the foregoing object, provided is a network identifier position determination method that includes the processes of: when a terminal is connected to a network system through a wired/wireless network, checking, at a network identifier position determination system, a network identifier that the terminal uses in order to be connected to the network system; checking position information of a user corresponding to the terminal that is connected to the network system using the network identifier; and mapping a determination position that is determined based on the checked position information to a position of the network identifier.

The network identifier position determination method may further include the processes of: storing the position information of the user in a database so as to match the network identifier; and in a case in which a plurality of pieces of position data including the position information is stored in the database for the same network identifier, when at least some of the plurality of pieces of position data stored in the database satisfies a predetermined standard, the process of mapping the determination position that is determined based on the checked position information to the position of the network identifier comprises determining the determination position based on the at least some of the plurality of pieces of position data that satisfies the predetermined standard.

The network identifier position determination method may further include the process of determining a new determination position by newly detecting position information that satisfies the standard for the same network identifier; and depending on whether position information corresponding to an existing determination position for a predetermined period is checked, determining whether to additionally map the new determination position to the network identifier or map the new determination position so as to substitute for the existing determination position.

The process of determining the determination position based on the at least some of the plurality of pieces of position data that satisfies the predetermined standard may include: determining one of the at least some of the plurality of pieces of position that satisfies the predetermined standard to be the determination position or determining a new position calculated using the position value of the at least some of the plurality of pieces of position data to be the determination position.

The network identifier position determination method may further include the processes of: receiving at least one of information about a connection position where the user is connected to the network system and information about whether or not the user has been connected to the network system from a user system corresponding to the user; and determining whether or not to map the determination position to the position of the network identifier based on the received information.

The network identifier position determination method may further include the process of receiving property information of the network identifier used by the terminal through the terminal. The process of mapping the determination position that is determined based on the checked position information to the position of the network identifier may include changing a way how to determine the determination position or a way how to map the determined determination position to the network identifier based on the received property information.

The network identifier position determination method may further include the processes of: when a plurality of network identifiers is used for the same user and determination positions respectively corresponding to the plurality of network identifiers are respectively determined by the network identifier position determination system, receiving information about whether or not the user has been connected to the network system at each of the determination positions or whether or not the user has been connected to the network system using each of the plurality of network identifiers from a user system corresponding to the user; and determining whether or not to map each of the determination positions to a corresponding network identifier of the plurality of network identifiers based on the received information.

The network identifier position determination method may further include the processes of: when a plurality of network identifiers is used for the same user and determination positions respectively corresponding to the plurality of network identifiers are respectively determined by the network identifier position determination system, checking, through a user system corresponding to the user or a network provider system, about whether or not the plurality of network identifiers is usable at the determination positions, respectively, or checking whether or not a predetermined network identifier standard is satisfied; and based on a result of the checking process, determining whether or not to map each of the determination positions to a corresponding network identifier of the plurality of network identifiers. The above-described network identifier position determination method may be stored in a computer readable recording medium in which a program for executing the method is recorded.

### Advantageous Effects

According to the present invention, it is possible to detect information on physical positions according to network identifiers in a relatively accurate manner and with a small error range, the physical positions being places where network identifiers are used, thereby significantly improving the performance of a service and a system that use the positions of the network identifiers.

Specifically, when a user is connected to a network system using a network identifier, this can be used for local information, such as local weather or local shopping information, or local marketing. The accuracy of position information is significantly improved over the accuracy of position information that is conventionally provided. This significantly contributes to user satisfaction as well as the development of the related industry.

In addition, several network identifiers are used by the same user when a legal user uses the several network identifiers while changing places or when an illegal user, such as a hacker or a cracker, is connected to the network system by illegally using the identification (ID) or password (PW) of the legal user without the knowledge of the legal user. In the latter case, it is possible to more accurately compare the positions according to the network identifiers with the actual position of the legal user, thereby stopping and preventing the network system from being illegally connected through the illegal use of private information. In particular, the available physical positions according to the network identifiers can be detected and stored in advance. Thus, when the illegal user is connected to the network system, it is possible to provide the physical positions of the network identifiers more rapidly and accurately than in the conventional approach, thereby stopping and preventing crimes.

Furthermore, when the network identifier is used at different positions in some circumstances, it is possible to detect the different positions by matching each of the different positions to the network identifier.

### DESCRIPTION OF DRAWINGS

A brief description will be made to respective figures for better understanding of the figures which are referred to in the detailed description of the present invention, in which:

FIG. 1 shows a schematic configuration for realizing a network identifier position determination method according to an embodiment of the present invention;

FIG. 2 shows a schematic configuration for realizing a network identifier position determination method according to another embodiment of the present invention;

FIG. 3 shows a schematic configuration for realizing a network identifier position determination method according to an embodiment of the present invention;

FIG. 4 is a view illustrating the process of determining the position of a network identifier in the network identifier position determination method according to an embodiment of the present invention; and

FIG. 5 shows an example in which the positions of network identifiers determined by the network identifier position determination method according to an embodiment of the present invention are stored.

### BEST MODE

The present invention, advantages associated with the operation of the present invention and objects that are realized by the practice of the present invention will be apparent from the accompanying drawings which illustrate exemplary embodiments of the present invention and the detailed description of the present invention which are illustrated in the drawings.

Throughout the specification, it will be understood that, when an element is referred to as “transmitting” data to another element, the element not only can directly transmit the data to another element but also indirectly transmit the data to another element via at least one intervening element.

In contrast, when an element is referred to as “directly transmitting” data to another element, the element can transmit the data to another element without an intervening element.

The present invention will now be described more fully hereinafter with reference to the accompanying drawings, in which exemplary embodiments thereof are shown. Reference should be made to the drawings, in which the same reference numerals are used throughout the different drawings to designate the same or similar components.

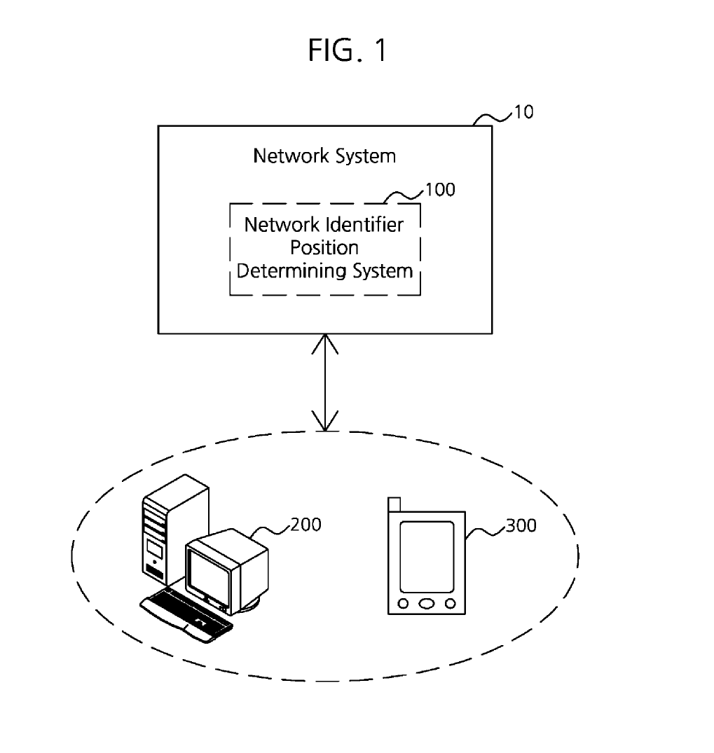

FIG. 1 shows a schematic configuration for realizing a network identifier position determination method according to an embodiment of the present invention.

Referring to FIG. 1, a network identifier position determination system 100 according to an embodiment of the present invention can be constructed as a part of a network system 10.

The network system 10 can be a system to which a user can be connected through a network, using a terminal 200. The network system 10 can be implemented as a variety of examples, such as a web server which provides web pages, a login server, a web application server (e.g. for games or instant messages), a mail server, a financial transaction authorization server, or so on.

The terminal 200 can be referred to as a terminal of a user, such as a computer, a tablet computer, a notebook computer, or so on, that the user uses in order to be connected to the network system 10. In some implementations, the terminal 200 can be a financial terminal which is used for financial transaction, such as a card payment device or an automatic teller machine (ATM). In this case, the terminal 200 can be a system that is connected to the network system 10, i.e. a system that approves financial transaction, such as payment, transfer or withdrawal, and helps the user perform a financial transaction.

The network system 10 can identify the user who corresponds to the terminal 200. It is preferred that the user corresponding to the terminal 200 be identified as the legal user of the terminal 200 which is connected to the network system 10 or, after being connected to the network system 10, makes a request (e.g. a login request, a request to inquire about or play main content, or a request for a specific function/service such as payment or transfer). The legal user of the terminal 200 may indicate the user who is authorized to use the terminal 200 which is a physical device. In addition, when a request is sent from the terminal 200 to the network system 10, the legal user of the terminal 200 may also indicate the legal user who can be provided with a service corresponding to the request from the network system 10. For instance, when the terminal 200 connected to the network system 10 makes a login request, the owner (user) of an account corresponding to the login request may be the legal user of the terminal 200. In addition, when the user requests for credit card payment or financial transaction involving a specific financial account using the terminal, the legal user of the terminal 200 may be the owner of the credit card or the owner of the specific financial account.

When the user is identified, the network identifier position determination system 100 can determine the position of the user. For this, the network system 10 can hold identification information (e.g. a telephone number, a media access control (MAC) address, or a subscriber identity module (SIM) address) of a mobile terminal 300 (i.e. the mobile terminal 300 of the user) corresponding to the terminal 200. For instance, the network system 10 can request the user to subscribe to a membership and receive the telephone number of the mobile terminal 300 as membership information. When the user logs in using the terminal 200 connected to the network system 10, the network system 10 can identify the mobile terminal 300 of the user according to the logged-in account. In some implementations, when the network system 10 provides preset services without login, the network system 10 can identify the user connected to the network system 10 using the identifier (e.g. a MAC address) of the terminal 200. In this case, the network system 10 can be the system that permits the user to use only the authorized terminal 200. Alternatively, the network system 10 can identify the user based on a means for requesting services depending on the type of the terminal 200 (e.g. a credit card, a check card, or a debit card).

The identification information of the mobile terminal 300 can be an example that can be used as information to detect the position of the user. For instance, the network identifier position determination system 100 can assume the position of the mobile terminal 300 to be the position of the user. The network identifier position determination system 100 can communicate with an external system (e.g. a mobile communication provider system or a location-based service (LBS) system) in order to detect the position of the mobile terminal 300. In addition, the position information of the mobile terminal 300 can be received from the external system.

In some implementations, the network identifier position determination system 100 can receive the position information of the mobile terminal 300 directly from the mobile terminal 300. For this, the mobile terminal 300 can have a means for determining its own position (e.g. a global positioning system (GPS) module). The mobile terminal 300 can also be equipped with an application that realizes the technical idea of the present invention. The network identifier position determination system 100 can receive the position information of the mobile terminal 300 using this application.

In some implementations, the network identifier position determination system 100 can detect the position of the user without using the position of the mobile terminal 300. For instance, when there is any type of service system (e.g. an LBS system or a mobile communication provider system) that knows the position of the user, the position information of the user can be received from this service system. For instance, when the user performs tagging on a device disposed at a predetermination position through near field radio frequency (RF) communication or when there is a service that requests the user to input his/her information or position by himself/herself, the position information of the user can be received from a service system that provides this service.

In a variety of ways as mentioned above, the network identifier position determination system 100 can determine the position information of the user of the currently-connected terminal 200.

When the terminal 200 is connected to the network system 10, the system 10 can check the network identifier (e.g. an Internet protocol (IP) address) that the terminal 200 uses. This is because the process in which the network system 10 checks the network identifier of the terminal 200 normally precedes the establishment of the session in which the terminal 200 is connected to the network system 10. Of course, the method of checking the network identifier may vary depending on the type of the network. In some network types, the network identifier may be a telephone number instead of an IP address. For instance, when the terminal 200 is a card payment device, the terminal 200 can be connected to the network system 10 through a public switched telephone network (PSTN) or a mobile communication network. In this case, the network identifier can be a telephone number that the terminal 200 uses. In some implementations, the network identifier position determination system 100 or the network system 10 can be provided with a means for checking the network identifier of the terminal 200. In any case, it is preferred that the network system 10 can identify the user who is using the terminal 200 that is currently connected to the network system 10.

Then, the network identifier position determination system 100 can determine the position of the network identifier that the terminal 200 is currently using based on the position of the user who is using the terminal 200.

According to the technical idea of the present invention, the network identifier position determination system 100 can detect the position of the user of the terminal 200 that is connected to the system using the network identifier, and once the position of the user is detected, determine the detected position of the user to be the position of the network identifier. For instance, the network system 10 can provide a location-based service using the position of the terminal 200 and the position of the user. In this case, it is highly possible that a client who newly subscribes to the location-based service is a legal user.

In this case, the network identifier position determination system 100 can detect the position of the user of the terminal 200 that is connected to the system using the network identifier, and once the position of the user is detected, determine the detected position of the user to be the position of the network identifier. Of course, in order to improve the accuracy of the position, it is possible to inquire of (or checking through) a user system (e.g. a wired/wireless communication system of the user, such as the terminal 200, the mobile terminal 300, or an email) of the user who is the subscriber to the service about whether or not the position of the terminal 200 connected to the system using the network identifier is static or whether or not the position of the terminal 200 is in a specific area. The detected position can be determined to be the position of the specific network identifier. Various other methods are also possible.

However, the terminal 200 may be used neither by the legal user of the logged-in account of the network system 10 nor by a person who is supposed to use the terminal 200. That is, another person (an agent or an illegal user such as a hacker or a cracker) may log in the system by the name of the legal user or request for a service or function using the terminal 200. In this case, the position of the network identifier and the position of the user may significantly differ from each other. In addition, in the case in which the position of the user is detected based on the position of the mobile terminal 300 of the user, it would not be desirable to directly map the position of the user to the position of the network identifier when the user does not possess the mobile terminal 300.

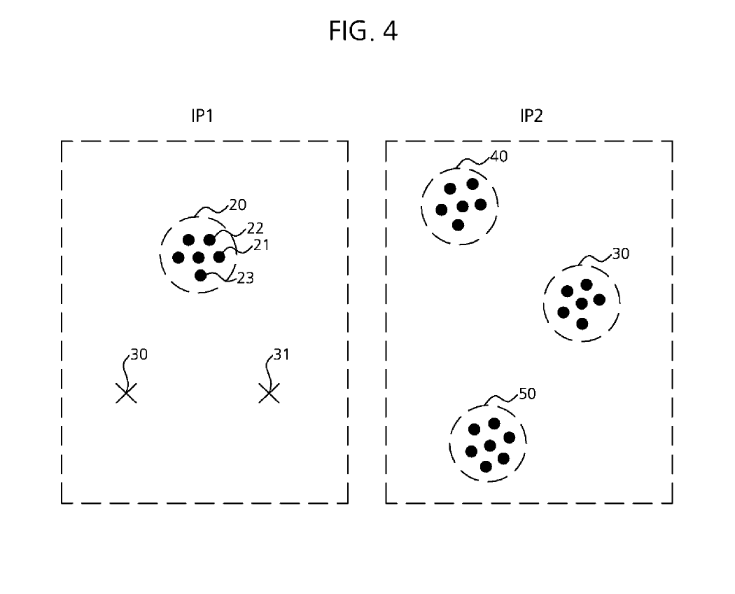

For this, according to the technical idea of the present invention, when the position of the user for a specific network identifier is repeated at a specific position (or similar positions) by at least a statistically-significant number, the specific position can be determined to be the position of the specific network identifier. This technical idea of the present invention will be described in more detail with reference to FIG. 4.

The conventional approach of determining the position corresponding to the network identifier depended simply on the scheme or rule by which the network provider (ISP) assigns the network identifier or on the information that the network provider has. In contrast, according to the technical idea of the present invention, it is possible to more accurately detect the position of the network by determining the position based on another parameter (i.e. the position of the user). In particular, the conventional approach can only detect the position of the network identifier based on the information that has a large error since this information indicates a large area, such as a village or street. In contrast, according to the technical idea of the present invention, the degree of error in the position information of the user is determined by an error in the position of the network identifier. In general, when the position information is detected based on the position of the mobile terminal 300, the position information of the user includes a GPS value or a value received from an external system. The error ranges from several meters to several hundred meters. Therefore, the range of the error in the position of the network identifier is significantly reduced compared to the conventional approach.

Although FIG. 1 illustrates the network identifier position determination system 100 as being constructed as a part of the network system 10, the network identifier position determination system 100 can be configured separate from the network system 10.

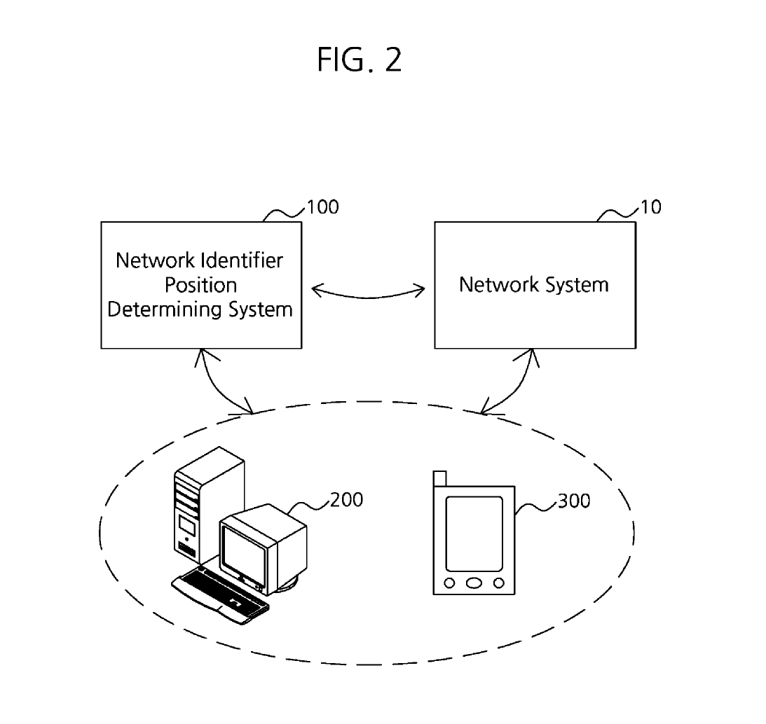

FIG. 2 shows a schematic configuration for realizing a network identifier position determination method according to another embodiment of the present invention.

Referring to FIG. 2, the network identifier position determination system 100 can be configured separate from the network system 10 and connected to the network system 10 through a wired/wireless network in order to transmit and receive information required for the realization of the technical idea of the present invention.

For instance, when the terminal 200 is connected to the network system 10, the network identifier position determination system 100 can receive information on the network identifier that the terminal 200 uses from the network system 10. In addition, when the network system 10 saves information about the mobile terminal 300 according to the user, the network identifier position determination system 100 can receive the information about the mobile terminal 300 from the network system 10. In some implementations, when the network system 10 detects information of the position of the user in the above-described manner, the network system 10 can, of course, transmit the detected information about the position of the user to the network identifier position determination system 100. It is apparent to a person skilled in the art to which the present invention relates that various other pieces of information required for the realization of the technical idea of the present invention can be transmitted and received between the network system 10 and the network identifier position determination system 100. In addition, a person skilled in the art to which the present invention relates can easily conceive that the network identifier position determination system 100 can be present in part inside and in part outside the network system 10 in order to realize the technical idea of the present invention.

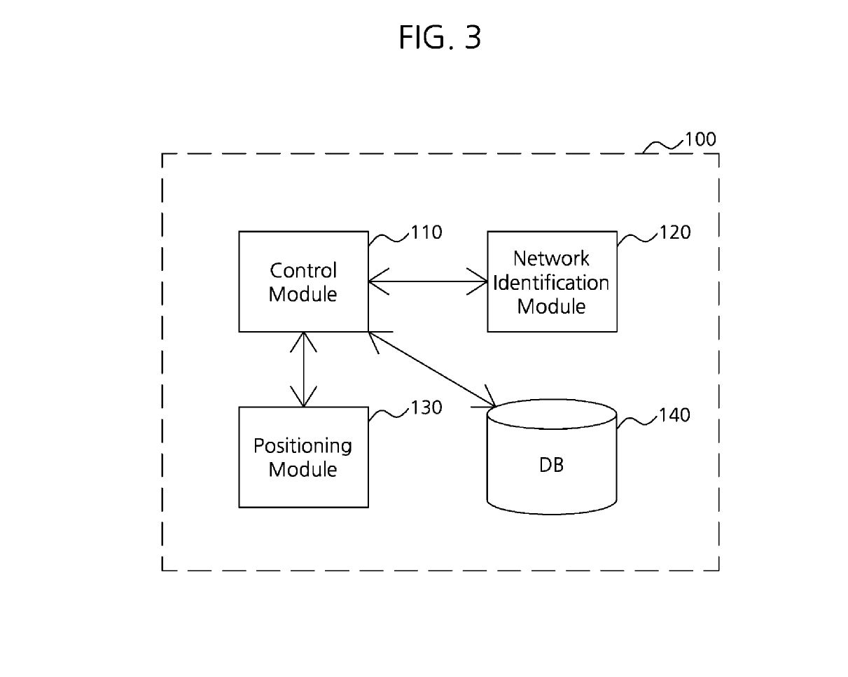

FIG. 3 shows a schematic configuration for realizing a network identifier position determination method according to an embodiment of the present invention.

Referring to FIG. 3, the network identifier position determination system 100 according to an embodiment of the present invention includes a control module 110, a network identification module 120 and a positioning module 130. The network identifier position determination system 100 may further include a database (DB) 140.

The network identifier position determination system 100 can be equipped with hardware and/or software resources required for the realization of the technical idea of the present invention, and is not necessarily a single physical part or one device. That is, the network identifier position determination system 100 may be a logical combination of the equipped hardware and/or software, and can be embodied as an assembly of logical elements that are disposed in separate devices as required in order to perform respective functions for the realization of the technical idea of the present invention. In addition, the network identifier position determination system 100 may be an assembly of elements that are embodied separately according to respective functions or roles in order to realize the technical idea of the present invention.

In addition, herein, the term “module” may indicate a functional and/or structural combination of hardware that will realize the technical idea of the present invention and software that will drive the hardware. For instance, the module may mean a logical unit of codes and hardware resources that will execute the codes. It should not be understood to a person skilled in the art to which the present invention relates that the codes are physically connected or that the hardware resources make one type of hardware.

The control module 110 can control the resources and/or functions of the other parts (e.g. the network identification module 120, the positioning module 130 and/or DB 140) in order to realize the technical idea of the present invention.

The network identification module 120 can check the network identifier that the terminal 200 connected to the network system 10 uses. The checking of the network identifier may mean not only that the network identification module 120 directly detects the network identifier that the terminal uses but also that the information on the detected network identifier is received from an external device, such as the network system 10. For instance, the network identification module 120 can receive the information on the network identifier that the terminal uses from the network system 10. When the network identifier position determination system 100 is embodied as a part of the network system 10, the network identification module 120 can directly detect the network identifier.

The network identifier may vary depending on the type of the network. For instance, when the network is the wired/wireless Internet, the network identifier may be an IP address. Irrespective of the type of the network, the network identifier is preferably a unique value that is assigned according to the network node present on the network.

The positioning module 130 can check the information on the user corresponding to the terminal 200. The user corresponding to the terminal 200 can be a specific user when the terminal 200 is intended to be used by the specific user. Alternatively, when the terminal 200 has executed a request, such as login, the use of content or financial transaction, in which the user can be identified, the user may be the user who has legal authority to make the request.

The positioning module 130 can receive the position information of the user from an external system (e.g. a mobile communication provider system or an LBS system) as described above in order to determine the position of the user corresponding to the terminal 200. The external system can detect the position of the mobile terminal 300 of the user and transmit the position to the positioning module 130. Of course, the position of the user can be detected without the use of the mobile terminal 300, and the external system can transmit the position information of the user to the positioning module 130 using any scheme.

In some implementations, the positioning module 130 can receive the position information of the mobile terminal 300 from the mobile terminal 300 of the user. For instance, the mobile terminal 300 can have the above-described means for determining its own position (e.g. a GPS module). The mobile terminal 300 can transmit position information determined by the position-determining means to the positioning module 130.

Then, the control module 110 can determine the position of the network identifier checked by the network identification module 120 based on the position information of the user checked by the positioning module 130.

In order for the control module 110 to determine the position of the network identifier using the position information of the user checked by the positioning module 130, it is preferred that the user who is using the terminal 200 be the legal user corresponding to the terminal 200. For instance, when user 2 logs in using the terminal 200 through the accountant of user 1, the position of the network identifier of the terminal 200 can be determined by the position of user 1. However, the position of user 1 may be completely different from the position of user 2.

Therefore, when the position of the user for a specific network identifier is repeatedly checked at a specific position or similar positions by at least a predetermined number, the control module 110 can determine the checked position to be the position of the specific network identifier.

In another case, a plurality of network identifiers corresponding to a specific legal user is present, the position information of the specific legal user corresponding to the plurality of network identifiers is checked by at least a predetermined number, and positions according to the plurality of network identifiers that satisfy preset standards can be determined. In this case, the control module 110 can receive information on whether or not the legal user has been connected to the network system 10 at the determination positions and information on whether or not the legal user has been connected to the network system 10 using the plurality of network identifiers from a user system corresponding to the legal user (e.g. a terminal, a mobile terminal or an email system of the legal user), and then can respectively map the determination positions to the plurality of network identifiers.

When different network identifiers are used at the same determination position, the control module 110 can inquire of the user system or the network provider system about whether or not the different network identifiers can be used at the determination position, or determine whether or not the different network identifiers satisfy preset network identifier determination standards, and then map the positions of the different network identifiers to the determination positions.

For instance, the network identifier position determination system 100 can check that the same legal user has been connected to the network system 10 using IP 1, IP 2 and IP 3. When IP 1 is used, position 1 can satisfy the preset standards and be determined to be a determination position. When IP 2 is used, position 2 can be determined to be a determination position that satisfies the preset standards. When IP 3 is used, position 3 can be determined to be a determination position that satisfies the preset standards.

In this case, when the legal user himself/herself has been actually connected to the network system 10 at position 1 using IP 1, at position 2 using IP 2, and position 3 using IP 3, it is preferred that the network identifier position determination system respectively map position 1, position 2 and position 3 to IP 1, IP 2 and IP 3.

Therefore, the control module 110 can inquire of the user system corresponding to the legal user (e.g. the terminal 200, the mobile terminal 300 or an email system of the legal user) about whether or not the legal user himself/herself has been connected to the network system 10 at position 1, position 2 and position 3, respectively. When the user has been actually connected at position 1, position 2 and position 3, respectively, the control module 110 can map position 1, position 2 and position 3 to IP 1, IP 2 and IP 3, as described above.

However, the result of the inquiry may indicate that the user has not been connected to the network system 10 at position 3 even though he/she has been connected to the network system 10 at position 1 and position 2. This may be the case in which the position of the user is determined to be position 3 although the user has been connected to the network system 10 at a different position. For instance, this may be the case in which the user has left the mobile terminal 300 at position 3. In this case, the control module 110 can receive information reporting that there has been no connection to the network system 10 at position 3 from the user system, and IP 3 may not be mapped to position 3. Therefore, the control module 110 can detect this case by additionally checking whether or not the user has left the mobile terminal 300 at position 3.

Of course, when the user knows network identifiers that he/she uses, it is possible to check whether or not to map the determination positions determined according to the network identifiers by checking whether or not the checked network identifiers IP 1, IP 2 and IP 3 are the network identifiers that the user uses.

In addition, there can be a case in which the user has not been connected to the network system 10 even if the position of the user is determined to be position 3 and the actual position of the user was position 3. This may be the case in which an unauthorized malicious user (e.g. a hacker) has been connected to the network system 10 through illegal use of the private information (e.g. login information) of the user or the case in which another person who is allowed by the user to be connected to the network system 10 at another position using IP 3. When the person is allowed by the user to have a connection, the user may inform the control module 110 of the allowance, and the control module 110 may not map IP 3 to position 3. However, when the user has not allowed the person to have a connection and the person has not been connected to the network system 10 at position 3, this may be the case in which the malicious user has been connected to the network system 10. Therefore, the control module 110 may not map IP 3 to position 3. It is also possible to check whether or not the malicious user is connected to the network system 10 through the illegal use the information of the user.

In addition, when the malicious user is connected to the network system 10 at a different position using a different network identifier IP 3, the position of the legal user may be checked to be position 3. However, position 3 may be a position where the legal user is actually connected to the network system 10. When the malicious user is repeatedly connected to the network system 10 using the network identifier IP 3, the determination position of the network identifier IP 3 may be determined to be position 3. In addition, when the legal user is mainly connected to the network system 10 using his/her network identifier (e.g. IP 2) at position 3 (e.g. a house or an office), the determination position of the network identifier IP 2 may also be determined to be position 3.

In this case, when different network identifiers are used at the same determination position, the control module 110 can inquire of the user system or the network provider system (e.g. an ISP system) about whether or not the different network identifiers are used at the determination position. When the user knows the network identifier (e.g. IP 2) that he/she uses at position 3, the user can inform that the user does not use the network identifier (e.g. IP 3) that is used by the malicious user. Alternatively, the control module 110 can inquire of the network provider about whether or not the network identifier IP 2 or IP 3 is assigned at position 3, and accordingly can determine whether or not to map the network identifier. In addition, when the different network identifiers (e.g. IP 2 and IP 3) are used at the same determination position (position 3), this may be caused by dynamic IP assignment, such as the dynamic host configuration protocol (DHCP), or an illegal use by a malicious user. In the case of the dynamic IP assignment protocol such as the DHCP, network identifiers are similar (for example, the last three numbers are different), and preset network identifier determination standards capable of defining the IP assignment protocol of the DHCP can be stored. When the standards are satisfied, position 3 can be mapped normally to IP 2 and IP 3. Otherwise, it is determined to be an illegal connection to or an illegal use of the network system 10 by the malicious user, and IP 3 may not be mapped to position 3.

It is also possible to additionally determine whether or not there is an illegal use of the private information by the malicious user.

FIG. 4 is a view illustrating the process of determining the position of a network identifier in the network identifier position determination method according to an embodiment of the present invention.

Referring to FIG. 4, the terminal 200 using a network identifier (e.g. IP 1) can be connected to the network system 10. Whenever the terminal 200 is connected to the network system 10, the positioning module 130 can check the position information of the user. A result can be produced by drawing a plurality of pieces of checked position information according to the position values, as shown in FIG. 4. In this case, the control module 110 can determine the position of the network identifier when at least one of the plurality of pieces of position information satisfies preset standards.

For instance, the standards require that the number of the pieces of position information, of which each position value is equal to or smaller than a predetermined distance, be equal to or greater than a predetermined number. As shown in FIG. 4, position information having position values corresponding to a position within a predetermined range or area 20 can be pieces of position information each having a position value that is equal to or smaller than the predetermined distance. Therefore, the control module 110 can determine the position of the network identifier (e.g. IP 1) when the number of pieces of position information (e.g. 21, 22 or 23) present in the area 20 is equal to or greater than a predetermined number. The position determined by the control module 110 can be the position of the area 20 or one position value from among the pieces of position information (e.g. 21, 22 or 23) present in the area 20. It is also possible to determine the position of the network identifier (e.g. IP 1) using a representative value (e.g. a median or intermediate value or an average value) of the position values of the pieces of position information present in the area 20.

In FIG. 4, position information 30 or position information 31 can be a piece of position information that is checked by the positioning module 130 when an illegal user, i.e. a person who is not the legal user of the terminal 200, is connected to the network system 10 (i.e. position information corresponding to the legal user). For instance, this may be the case in which an unauthorized malicious user is connected to the network system 10 or the case in which another person allowed by the legal user is connected to the network system 10 to use a service.

When the position of the user is determined based on the position of the mobile terminal 300 of the user, the position information 30 or 31 may be a piece of position information when the user has been connected to the network system 10 without possessing the mobile terminal 300 at a predetermined distance or more from the mobile terminal 300. In any case, according to technical idea of the present invention, there is no consideration of the position information 30 and/or the position information 31 as described above when the control module 110 determines the position of the network identifier (e.g. IP 1). Therefore, pieces of improper position information for the positions of the network identifier (e.g. IP 1) are filtered.

When the positions of the user (or the positions of the mobile terminal 300) are the same, the position information 21 determined by the positioning module 130 (or the position information 21, 22 and 23 of the mobile terminal 300) may differ more or less, as shown in FIG. 4. This may be an error in measurement when the position of the mobile terminal 300 is determined, for example, using the GPS or by triangulation. However, such an error is significantly reduced than an error in the conventional approach in which an ISP system measures the position of the network identifier.

A specific network identifier (e.g. IP 2) may have a plurality of areas (e.g. 30, 40 and 50) each of which is composed of a plurality of close positions present inside a predetermined range. In this case, the control module 110 can determine a plurality of positions for the network identifier (e.g. IP 2). This can be the case in which the specific network identifier (e.g. IP 2) is used at a plurality of positions as in the case in which the network provider dynamically assigns the network identifier. For instance, the specific network identifier (e.g. IP 2) can be an identifier that an ISP system assigned to a house (or an office). In this case, the position of the user corresponding to the terminal using the specific network identifier (e.g. IP 2) can be one piece of position information from a plurality of pieces of position information present in the area 40. Afterwards, the specific network identifier (e.g. IP 2) can be assigned to another house (or office). At this time, the position of the user corresponding to the terminal using the specific network identifier (e.g. IP 2) can be one piece of position information from a plurality of pieces of position information present in the area 30. Therefore, the physical positions of the specific network identifier (e.g. IP 2) can be the positions corresponding to the area 30 and the area 40. According to the technical idea of the present invention, it is possible to detect all positions to which the specific network identifier (e.g. IP 2) can be assigned.

In addition, when a private network such as a virtual private network (VPN) is used, as shown in the right part of FIG. 4, a plurality of positions can be determined to be the positions of the same network identifier (e.g. IP 2). For instance, when a company uses a VPN network, the network identifier (e.g. IP 2) can be a public IP that is used when a VPN server is connected to an external network, and the individual areas 30, 40 and 50 can be individual pieces of position information of terminals that are respectively used by the employees of the company. Of course, when a VPN client uses a public IP, the position information of the public IP can be mapped to the position information of the user corresponding to the VPN client.

In this manner, in order to determine the position of the network identifier (e.g. IP 1 and IP 2), the control module 110 can store the position of the user in the DB 140 so as to match the position of the network identifier whenever the terminal 200 is connected to the network system 10 and the position of the user corresponding to the terminal 200 is checked. The position information stored in the DB 140 will be defined as position data. Then, the control module 110 can determine the positions according to the network identifiers, as shown in FIG. 4, using the position data stored in the DB 140.

Once the positions according to the specific network identifiers are determined, the positions of the network identifiers can stay unless another position satisfies preset standards shown in FIG. 4 (i.e. at least a predetermined number of pieces of position information is present in a predetermined range). However, position information at a predetermined distance or more from the determination position, which is already determined to be the position of the specific network identifier, can be checked repeatedly. In addition, when pieces of position information at a predetermined distance or more from the determination position newly satisfy the standards, the control module 110 can change the determination position that is determined for the network identifier to another determination position that newly satisfies the standards.

The network identifier position determination system can determine whether to additionally map the determination position for the specific network identifier or change the already-mapped determination position.

For instance, when the pieces of position information that satisfy the above-described preset standards for the specific network identifier are newly checked, the control module 110 can monitor whether or not position information corresponding to the existing determination position for a predetermined period has been detected. When the position information corresponding to the existing determination position is detected after the new determination position is determined, the control module 110 can additionally map the new determination position to the network identifier. When no position information corresponding to the existing determination position for the predetermined period has been detected, the control module 110 can map the new determination position so as to substitute for the existing determination position.

The control module 110 can receive information about a connection position where the user is connected to the network system 10, whether or not the user allowed another person to be connected to the network system 10, whether the user has been connected to the network system 10, or the like through communication with the user system corresponding to the user (e.g. any type of system, such as the terminal 200, the mobile terminal 300 or an email system, with which the user can have communication with the control module 110).

The received information can be used in determining whether or not to map the determination position to the position of the network identifier, whether or not to substitute the determination position for the existing determination position, and/or whether or not to additionally map the determination position to the position of the network identifier.

For instance, the new determination position can be determined by the control module 110 in the state in which the determination position corresponding to the network identifier IP 1 is present. This may be the case, for example, in which the network identifier IP 1 is used at another physical position (e.g. the DHCP as described above). In this case, the new determination position can be additionally mapped to the network identifier IP 1. The network provider may assign the network identifier IP 1 to another physical position. In this case, it is preferred that the new determination position can be mapped to the network identifier IP 1. In addition, while the physical position where the network identifier IP 1 is used stays the same, the checked position of the user may be repeatedly determined to be different from the existing determination position. This may be the case in which the user repeatedly leaves the mobile terminal 300 at a place (e.g. his/her house or office). Therefore, when the new determination position is generated, the control module 110 can check whether or not the new determination position is a position available for the physical position where the network identifier is used by inquiring of the user about the connection position where the network system 10 is connected. When the new determination position differs from the checked connection position by at least a predetermined error range, the new determination position may not be mapped to the network identifier.

When the illegal malicious user is repeatedly connected to the network system 10 using the private information of the legal user, a position (i.e. a position of the legal user) that is different from the position mapped to the network identifier that the illegal user uses can be generated as a new determination position of the network identifier which the illegal user uses. In this case, when the new determination position is generated, the control module 110 can check whether or not the legal user has been connected to the network system 10 through the user system (e.g. mobile terminal 300 or the email) of the legal user. When the legal user has not been connected to the network system 10, the generated position may not be mapped to the network identifier (i.e. the network identifier that the illegal user uses).

Since the case of newly checking the determination position that satisfies the above-described standards is not frequent, the procedure of inquiring of the legal user about a connection position and/or whether or not a connection to the network system is made is not frequently carried out. Therefore, the inconvenience of the legal user is not significant.

The control module 110 can check the property information of the network identifier that the terminal 200 uses. The property information of the network identifier may include information on how to assign the network identifier (e.g. information on whether the network identifier is a static network identifier or a dynamic network identifier, or whether or not the network is a VPN network). The network identifier position determination system 100 and/or the network system 10 can receive the property information from the user system corresponding to the user, and the control module 110 can inquire of the network provider (e.g. an ISP system) about the property information.

Then, the control module 110 can change the way of determining the determination position based on the received property information or the way of mapping the determined determination position to the network identifier. For instance, the control module 110 can change the above-described standards of determining the determination position (e.g. the number of pieces of position information that are present at or within a predetermined distance) depending on whether the specific network identifier is a static IP or a dynamic IP. When the determination position is newly determined, it is possible to determine whether to add the new determination position to the network identifier or substitute the determined determination position for the existing determination position depending on whether the specific network identifier is the static IP, the dynamic IP, or the IP used in the VPN. Therefore, it is possible to determine the determination position of the network identifier or map the determined determination position in a more effective manner.

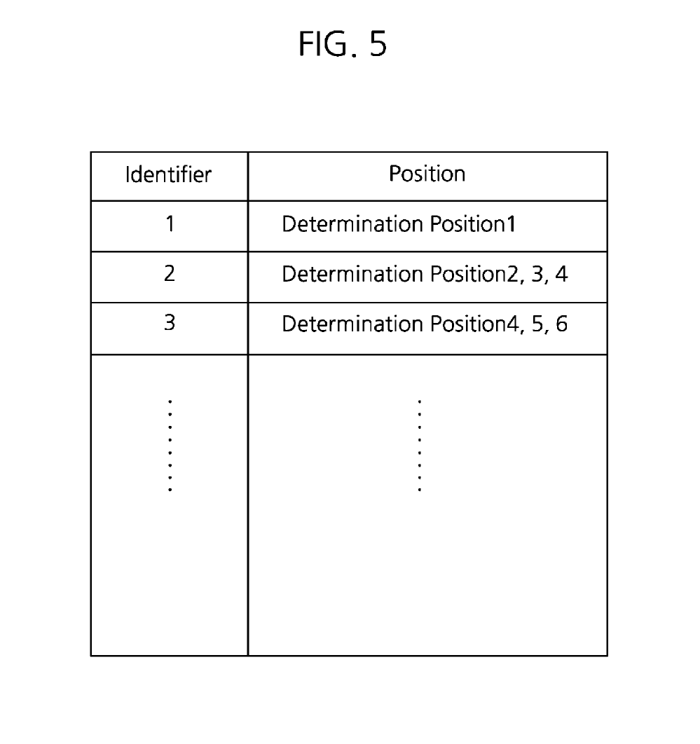

FIG. 5 shows an example in which the positions of network identifiers determined by the network identifier position determination method according to an embodiment of the present invention are stored.

Referring to FIG. 5, due to the network identifier position determination method according to an embodiment of the present invention, DB 140 can hold therein predetermination positions determined according to network identifiers. Only one determination position (determination position 1) can be mapped to a specific network identifier (identifier 1).

A plurality of determination positions (determination positions 2, 3 and 4) can be mapped to another identifier (identifier 2). A plurality of determination positions (determination positions 4, 5 and 6) can be mapped to a further identifier (identifier 3). In addition, as shown in FIG. 5, one determination position (determination position 4) can be mapped to different identifiers (identifiers 2 and 3). This may occur when network identifier is dynamically assigned as in the DHCP.

According to the technical idea of the present invention as set forth above, it is possible to map at least one available position according to the network identifier. It is possible to significantly improve the accuracy of the detection of the position according to the network identifier compared to the conventional approach.

In addition, it is possible to filter the position of the user that is detected when there is an unexpected user or the user does not possess the mobile terminal 300 using preset conditions as described above. It is therefore possible to more accurately detect the position according to the network identifier.

Furthermore, since the available position is mapped according to the network identifier, when an illegal malicious user is connected to the network system 10 using the private information of a legal user, it is possible to easily and rapidly check the actual position of the legal user and the position of the network identifier which is used by the illegal user. In addition, at this time, the network identifier position determination system 100 can immediately inquire of the DB 140 about the position of the network identifier of the terminal 200 connected to the network system 10 without checking the position through the external system in every case.

The embodiments of the network identifier position determination method according to the present invention can be embodied as computer readable codes that are stored in a computer readable recording medium. The computer readable recording medium includes all sorts of record devices in which data that are readable by a computer system are stored. Examples of the computer readable recording medium include read only memory (ROM), random access memory (RAM), compact disc read only memory (CD-ROM), a magnetic tape, a hard disc, a floppy disc, an optical data storage device and the like. Further, the recording medium may be implemented in the form of a carrier wave (e.g. Internet transmission). In addition, the computer readable recording medium may be distributed to computer systems on the network, in which the computer readable codes are stored and executed in a decentralized fashion. In addition, functional programs, codes and code segments for embodying the present invention can be easily construed by programmers having ordinary skill in the art to which the present invention pertains.

While the present invention has been described with reference to the certain exemplary embodiments shown in the drawings, it will be understood by a person skilled in the art that various modifications and equivalent other embodiments may be made therefrom. Therefore, the true scope of the present invention shall be defined by the concept of the appended claims.

### INDUSTRIAL APPLICABILITY

The present invention is applicable to a variety of services that uses the physical position of the network identifier.

1. A network identifier position determination system comprising:
a network identification module, wherein, when a terminal is connected to a network system through a wired/wireless network, the network identification module checks a network identifier that the terminal uses in order to be connected to the network system;
a positioning module which checks position information of a user corresponding to the terminal that is connected to the network system using the network identifier; and
a control module which maps a determination position that is determined based on the position information checked by the positioning module to a position of the network identifier.

2. The network identifier position determination system according to claim 1, wherein the positioning module checks position information of a mobile terminal of the user.

3. The network identifier position determination system according to claim 1, further comprising a database,
wherein the control module stores the position information of the user in the database so as to match the network identifier, and in a case in which a plurality of pieces of position data including the position information is stored in the database for the same network identifier, when at least some of the plurality of pieces of position data stored in the database satisfies a predetermined standard, determines the determination position based on the at least some of the plurality of pieces of position data that satisfies the predetermined standard.

4. The network identifier position determination system according to claim 3, wherein the predetermined standard comprises a case in which a position value of each of the at least some of the plurality of pieces of position data is present at a predetermined distance or less and the number of the at least some of the plurality of pieces of position data is equal to or greater than a predetermined number.

5. The network identifier position determination system according to claim 4, wherein the control module determines one of the at least some of the plurality of pieces of position that satisfies the predetermined standard to be the determination position or determines a new position calculated using the position value of the at least some of the plurality of pieces of position data to be the determination position.

6. The network identifier position determination system according to claim 1, wherein the determination position can be plural for the same network identifier, or the network identifier mapped at the same determination position can be plural.

7. The network identifier position determination system according to claim 3, wherein, when position information that satisfies the standard for the same network identifier is newly detected and a new determination position is determined, the control module is able to change a way how to map the new determination position to the network identifier depending on whether position information corresponding to an existing determination position for a predetermined period is checked.

8. The network identifier position determination system according to claim 1, wherein the control module receives at least one of information about a connection position where the user is connected to the network system and information about whether or not the user has been connected to the network system from a user system corresponding to the user, and determines whether or not to map the determination position to the position of the network identifier based on the received information.

9. The network identifier position determination system according to claim 1, wherein the control module receives property information of the network identifier used by the terminal through the terminal, and changes a way how to determine the determination position or a way how to map the determined determination position to the network identifier based on the received property information.

10. The network identifier position determination system according to claim 1, wherein, when a plurality of network identifiers are used for the same user and determination positions respectively corresponding to the plurality of network identifiers are respectively determined, the control module receives information about whether or not the user has been connected to the network system at each of the determination positions or whether or not the user has been connected to the network system using each of the plurality of network identifiers from a user system corresponding to the user, and determines whether or not to map each of the determination positions to a corresponding network identifier of the plurality of network identifiers based on the received information.

11. The network identifier position determination system according to claim 1, wherein, when a plurality of network identifiers are used for the same user and determination positions respectively corresponding to the plurality of network identifiers are respectively determined, the control module checks, through a user system corresponding to the user or a network provider system, about whether or not the plurality of network identifiers is usable at the determination positions, respectively, or checks whether or not a predetermined network identifier standard is satisfied, and based on a result of the checking process, determines whether or not to map each of the determination positions to a corresponding network identifier of the plurality of network identifiers.

12. A network identifier position determination system
a network identification module, wherein, when a terminal is connected to a network system through a wired/wireless network, the network identification module checks a network identifier that the terminal uses in order to be connected to the network system;
a positioning module which checks position information of a user corresponding to the terminal that is connected to the network system using the network identifier; and
a control module, wherein, in a case in which a plurality of pieces of different position information checked by the positioning module is present, when at least some of the plurality of pieces of different position information satisfies a predetermined standard, the control module maps a new position to a position of the network identifier, the new position being mapped as one piece of position information of the at least some of the pieces of position information or being calculated using a position value of the at least some of the pieces of position information.

13. A network identifier position determination method comprising:
when a terminal is connected to a network system through a wired/wireless network, checking, at a network identifier position determination system, a network identifier that the terminal uses in order to be connected to the network system;
checking position information of a user corresponding to the terminal that is connected to the network system using the network identifier; and
mapping a determination position that is determined based on the checked position information to a position of the network identifier.

14. The network identifier position determination method according to claim 13, further comprising storing the position information of the user in a database so as to match the network identifier,
wherein, in a case in which a plurality of pieces of position data including the position information is stored in the database for the same network identifier, when at least some of the plurality of pieces of position data stored in the database satisfies a predetermined standard, the process of mapping the determination position that is determined based on the checked position information to the position of the network identifier comprises determining the determination position based on the at least some of the plurality of pieces of position data that satisfies the predetermined standard.

15. The network identifier position determination method according to claim 14, further comprising:
determining a new determination position by newly detecting position information that satisfies the standard for the same network identifier; and
depending on whether position information corresponding to an existing determination position for a predetermined period is checked, determining whether to additionally map the new determination position to the network identifier or map the new determination position so as to substitute for the existing determination position.

16. The network identifier position determination method according to claim 14, wherein the process of determining the determination position based on the at least some of the plurality of pieces of position data that satisfies the predetermined standard comprises determining one of the at least some of the plurality of pieces of position that satisfies the predetermined standard to be the determination position or determining a new position calculated using the position value of the at least some of the plurality of pieces of position data to be the determination position.

17. The network identifier position determination method according to claim 13, further comprising:
receiving at least one of information about a connection position where the user is connected to the network system and information about whether or not the user has been connected to the network system from a user system corresponding to the user; and
determining whether or not to map the determination position to the position of the network identifier based on the received information.

18. The network identifier position determination method according to claim 13, further comprising receiving property information of the network identifier used by the terminal through the terminal,
wherein the process of mapping the determination position that is determined based on the checked position information to the position of the network identifier comprises changing a way how to determine the determination position or a way how to map the determined determination position to the network identifier based on the received property information.

19. The network identifier position determination method according to claim 13, further comprising: when a plurality of network identifiers is used for the same user and determination positions respectively corresponding to the plurality of network identifiers are respectively determined by the network identifier position determination system,
receiving information about whether or not the user has been connected to the network system at each of the determination positions or whether or not the user has been connected to the network system using each of the plurality of network identifiers from a user system corresponding to the user; and
determining whether or not to map each of the determination positions to a corresponding network identifier of the plurality of network identifiers based on the received information.

20. The network identifier position determination method according to claim 13, further comprising: when a plurality of network identifiers is used for the same user and determination positions respectively corresponding to the plurality of network identifiers are respectively determined by the network identifier position determination system,
checking, through a user system corresponding to the user or a network provider system, about whether or not the plurality of network identifiers is usable at the determination positions, respectively, or checking whether or not a predetermined network identifier standard is satisfied; and
based on a result of the checking process, determining whether or not to map each of the determination positions to a corresponding network identifier of the plurality of network identifiers.

21. A non-transitory computer readable recording medium in which a program for executing the method claimed in claim 13 is recorded.
